(19) United States
(12) Patent Application Publication
(10) Pub. No.: US 2021/0138652 A1
(43) Pub. Date: May 13, 2021

(54) Robot Control Using Model-Predictive Interaction

(71) Applicant: PILZ GMBH & CO. KG, Ostfildern (DE)

(72) Inventors: Tobias GOLD, Boehmenkirch (DE); Andreas VÖLZ, Ulm (DE); Knut GRAICHEN, Ostfildern (DE); Joachim SCHLEICHER, Ostfildern (DE); Roman KRETZSCHMANN, Ostfildern (DE)

(21) Appl. No.: 17/085,632

(22) Filed: Oct. 30, 2020

(30) Foreign Application Priority Data
Oct. 30, 2019 (DE) 10 2019 129 338.3

(51) Int. Cl. B25J 9/16

(52) U.S. Cl. CPC B25J 9/1671

(57) ABSTRACT

A method and an apparatus for controlling a robot during an interaction with its environment includes solving an optimization problem for calculating an optimal control variable as an input for a robot controller. The optimization problem is based on interaction dynamics and robot dynamics.

### CROSS-REFERENCE TO RELATED APPLICATIONS

This application claims priority to German Application No. 10 2019 129 338.3 filed Oct. 30, 2019, the entire disclosure of which is incorporated by reference.

### FIELD

The present invention relates to a method and apparatus for controlling a robot.

### BACKGROUND

Robots, especially industrial robots, are no longer used in isolation, but increasingly in an environment where they must collaborate with humans or other robots. This makes it increasingly difficult to control a robot.

One way to control complex and multi-variable processes is the so-called model predictive control (MPC). In MPC, a dynamic model of the process to be controlled is used to calculate the future behavior of the process depending on the input signals and the current measured values. This allows the calculation of optimal input signals, which lead to optimal output signals. Input, output and state restrictions can be considered simultaneously. The model behavior is predicted (predicated) up to a certain time horizon Tₕₒᵣ, but usually only the input signal to the next time step is used and then the optimization is repeated based on the achieved state. Due to this feedback, MPC is a closed-loop control as opposed to an optimum control.

DE 10 2017 129 665 shows an example of a robot control using model predictive control. Here the aim of the control system (control target) is to find a collision-free movement path so that the robot can move from one position in space to another without colliding with a static or dynamic obstacle.

For a real human-machine-collaboration, collision avoidance is not sufficient. Instead, the robot must be able to cooperate directly with humans, touch them or be guided by them. Contact between humans and robots is thus inevitable.

### SUMMARY

It is an object to specify a method as well as a device enabling a robot to be controlled during an interaction with its environment. Further, it is an object to specify a control procedure that allows cooperation between humans and robots as natural as possible. Yet further, it is an object to specify a controller that can be implemented easily and cost-effectively. Finally, it is an object to specify a controller that can be flexibly adapted to different applications.

According to an aspect of the present invention, there is provided a method for controlling a robot during an interaction with its environment by solving an optimization problem for calculating an optimal control variable as an input for a robot controller, wherein the optimization problem considers (includes) interaction dynamics and robot dynamics.

According to a further aspect of the present invention, there is provided a device for controlling a robot during an interaction with its environment with a control variable determination unit, which is configured to calculate an optimal control variable as an input for a robot controller by solving an optimization problem, wherein the optimization problem considers interaction dynamics and robot dynamics.

It is thus an idea of the present disclosure to consider not only the robot dynamics but also an interaction dynamics in model predictive control. In other words, the optimization problem takes into account not only the robot dynamics, but also interaction forces that occur over time.

The interaction forces are those forces that act upon the robot due to the interaction with its environment, for example forces that arise from contact with a human, object, or are caused by a conscious guidance of the robot by the human. The interaction forces are thus essentially contact forces that act on the robot in addition to natural forces (inertial, centripetal and Coriolis forces) and gravity.

By taking into account these interaction forces, a force and yield control for a robot can be realized directly. Directly means that control based on interaction forces is integrated into the model predictive control. Thereby, a uniform approach can be adopted, wherein different force and yield controls can be used for different applications without having to use a different control methodology. This means that different applications can be realized without changing the type of controller, since the robot dynamics remain the same. Considering the interaction of a robot with its environment is therefore not only easily possible, but also flexibly adaptable to different tasks.

MPC, i.e. the optimization-based methodology, can also be variably extended by considering state- and control variable-dependent equality and inequality constraints. Thus, essential control tasks of a robot can be realized with a uniform methodology, wherein dependencies between the control tasks of the individual control can be taken into account. In this way, a more natural behavior of the robot can be achieved, since the control tasks can be realized without a break in the methodology. The method therefore offers a uniform control approach for yield, force and motion control as well as hybrid forms of these.

The robot dynamics can be a dynamic model of the robot, in which, for example, dynamic components are dependent on control variables and state variables of the robot. The interaction dynamics can be a dynamic force model in which dynamic components are dependent on robot states, for instance a robot movement.

Thus, for robot dynamics and interaction dynamics, own models can be used, which describe their respective scope. Furthermore, these models can be interlinked to express mutual dependencies. Known models can be reused for robot dynamics, which can be derived from a generally valid system of differential motion equations or simplifications thereof. Reusing known approaches of model predictive control for robot control makes implementation easy and cost-effective.

According to the described method, the optimization problem can have a cost function that weights the interaction forces.

It is therefore possible to evaluate dedicated interaction forces during control. For example, in the case of an interaction, movement of a joint in one direction could cause an increase in external torque, wherein movement in the other direction causes a decrease in external torque. The external torques result from the interaction forces. Thereby, a robot actively gives way on contact.

In a further refinement, the cost function can weigh the interaction forces, control variables and states of the robot. It is thus possible to consider and link the interaction forces, control variables and states with a single quality function. Thereby, dependencies between the variables can be considered in a single optimization. The refinement contributes to a standardization of the control system, in which different aspects of robot control can be solved by a single optimization problem.

In a further refinement, the cost function can be designed to minimize the interaction forces. In other words, the control target of the optimization can be designed to minimize the forces acting externally on the robot, thus achieving evasive behavior of the robot. Thereby, the risk of injury in human-robot collaboration can be reduced by allowing contact between the robot and an object while the robot is still trying to yield as actively as possible.

In a further refinement, the cost function can also be designed to optimize the interaction forces to a target value. Thereby, instead of retreating under the influence of an interaction force, the robot can also be controlled to maintain a certain force. This refinement thus enables force control instead of yield control, wherein a combination of both types of behavior is also conceivable. The control procedure can thus cover different applications.

The dynamic force model can be a description of the change of an external torque or force depending on a stiffness of an environment interacting with the robot as well as a joint velocity or a Cartesian velocity of the robot.

The stiffness of the dynamic force model during interaction can be assumed to be non-zero, and in a non-interacting state zero. Thereby, it is possible to distinguish between an interaction state and a non-interaction state, wherein the consideration of the force model only takes place in an interaction state and is not taken into account for the rest. Applying the force model dynamically and only when it is required, further optimizes the control system as a whole.

The stiffness of the dynamic force model can also be assumed constant. This assumption can be used to simplify the force model for corresponding applications, such as a hand guidance of the robot. This facilitates solving the optimization problem and reduces the resource consumption for the calculation.

It goes without saying that the features mentioned above and those to be explained below can be used not only in the combination indicated in each case, but also in other combinations or on their own, without leaving the scope of the present invention.

### BRIEF DESCRIPTION OF THE DRAWINGS

Embodiments of the invention are shown in the drawings and are explained in more detail in the following description.

FIG. 1 is an overview of a control system according to an embodiment of the present disclosure.

FIG. 2 is a formal representation of an optimization problem without considering interaction dynamics.

FIG. 3 is a formal representation of an optimization problem that takes into account the interaction dynamics of a hand movement.

FIG. 4 is a formal representation of an optimization problem that takes into account interaction dynamics in hybrid force/movement control.

FIG. 5 is a schematic diagram illustrating the estimation of stiffness.

### DETAILED DESCRIPTION

FIG. 1 shows an overview of a method 10 for controlling a robot 12.

A robot 12—for example, an industrial robot—is depicted in the middle of FIG. 1. Industrial robots are universal, programmable machines for handling, assembling, and processing work pieces. Generally, an industrial robot includes a manipulator (robot arm), a controller and an effector, which can be a tool such as a gripper.

On the left side, a model predictive controller (MPC) 14 is indicated. The controller determines a control variable u as input 18 for the robot 12 starting from a target 16, which is specified here as Cartesian coordinate X_{des}. Based on the input 18, the drives of the robot 12 are set so that a defined movement (q, \dot{q}) is performed. The basic principle of model predictive control using robot dynamics is explained in the following with reference to FIG. 2.

On the right side the environment 20, with which robot 12 interacts, is indicated. Forces 22 (hereafter referred to as interaction forces) acting on the robot 12 represent the interaction with the environment 20. The interaction forces 22 can be contact forces that result from contact with an object in the environment 20. In model predictive control of robots, interaction forces have so far not been taken into account directly.

FIG. 3 and FIG. 4 each show embodiments of a method, which take into account the interaction forces 22 in model predictive control. In the following, these methods are referred to as MPIC (model predictive interaction control).

MPIC considers interaction dynamics in addition to robot dynamics by introducing a force dynamics equation, which describes the behavior of the interaction forces 22 (Fₑₓₜ) or the resulting torques τₑₓₜ∈R^{N}.

The interaction dynamics thus describes the behavior of the interaction forces acting on the robot structure. In MPIC, interactions are therefore taken into account directly. The optimization problem to be solved with MPIC differs from the normal MPC only in the choice of the cost function and any restrictions. Apart from that, the system, especially the robot dynamics, remains the same. Therefore, known equality and inequality restrictions for states and control variables from the robot controller according to MPC can still be used in MPIC.

In general, an industrial robot can be described by a system of differential equations of motion:

M(q)\ddot{q}+C(q,\dot{q})\dot{q}+g(q)+τₑₓₜ=τⱼ

M is the mass inertia matrix, vector C is the generalized constraining torques caused by centripetal and Coriolis forces in the joints, and g is the vector of the generalized gravitational torques. τⱼ describes the torque transmitted by the gear, which is the result of the motor torque minus the frictional torques of the motor and the gearbox. q(t) is the vector of the movement coordinates of the axes. τₑₓₜ maps the external influences that affect the balance of torques and includes, among other things, the torques of interaction. The external torque τₑₓₜ:

τₑₓₜ=J^{T}(q)Fₑₓₜ

can be calculated via a configuration-dependent link.

FIG. 2 shows a formal representation of a dynamic optimization problem according to MPC, which is here designated in its entirety by the reference number 24. The starting point is the system model, which describes the robot dynamics 26 of the moving system, for example the manipulator, with states 28 and control variables 30. For position or velocity control, robot dynamics 26 can be simplified as integrator \dot{q}=u with the states x=q and the control variables a or as double integrator \ddot{q}=u with the states x [q^{T}, \dot{q}^{T}]T and the control variables u=\ddot{q}.

A cost function 32 weights the states 28 and control variables 30. The task of optimization is to find the optimal control function from the usually infinite number of control functions, taking into account constraints 34, which the cost function 32 minimizes in order to determine an optimal control variable as input 18 for a robot controller.

MPIC according to FIG. 3 and FIG. 4 supplements the optimization problem according to MPC 24 by considering interaction dynamics 36 in addition to robot dynamics 26. The interaction dynamics 36 can be a force dynamics equation 38 to describe the behavior of the external forces 22 (Fₑₓₜ) or the resulting external torques τₑₓₜ. The interaction forces 22 can thus be considered as further states to be captured and weighted by the optimization problem.

FIG. 3 shows an optimization problem 40 according to an example embodiment of MPIC. In the depicted example, the control system realizes a hand guidance of the robot. The force dynamics equation 38 (in the joint space) is:

\dot{τ}ₑₓₜ=Kₑ\dot{q}

Here, the idea is that in a case of interaction, movement in one direction causes an increase in the external torque, whereas movement in the opposite direction causes a decrease in the external torque. The cost function is designed to minimize the external torques. This leads to a yield control, according to which the robot tries to back off when touched. The stiffness Kₑ is selected here as constant.

The application for the above control is a hand guidance of the robot by humans. The yield control makes it possible to “steer” the robot by touch. If someone touches the robot and pushes it in one direction, the robot moves away in that direction. The robot thus follows the human in a natural way.

FIG. 4 shows another optimization problem 40 according to an example embodiment of MPIC. Here the control system realizes a hybrid force/motion control.

Hybrid force/motion control distinguishes between motion-controlled and force-controlled Cartesian directions, i.e. force control is performed in one defined Cartesian direction, while position control is performed in another Cartesian direction.

A possible application for hybrid force/motion control can be the wiping of a blackboard. Here, force control is applied in the direction of the board (z-direction) so that a sponge is pressed onto the board with a defined pressure. Along the writing direction of the board (x-direction), position control is performed to enable a smooth feed. Perpendicular to the writing direction and parallel to the board (y-direction) force control can be applied again, so that the robot can be pressed into a new line by a human.

FIG. 4 shows a corresponding optimization problem 40 in Cartesian space. The force dynamics equation 38 (in Cartesian space) is here:

\dot{F}ₑₓₜ=KₑJ(q)\dot{q}

A connection between Cartesian space and joint space can be established via the Jacobi matrix J(q).

In the optimization problem 40 for a force/motion control, the cost function 32 considers both a deviation to a desired Cartesian position and a deviation from a desired force.

Both the optimization problem according to FIG. 3 and the optimization problem according to FIG. 4 have the same robot dynamics 26, namely:

\ddot{q}=M(q)⁻¹(τₘ−C(q,\acute{q})−g(q)+τₑₓₜ)

The optimization problem of the two applications thus only differs in the additional forces equation 38, the cost function 32 and additional constraints 34.

In principle, the external forces 22 are only considered in the case of interaction. This can be achieved by assuming a virtual stiffness during a free movement equal to zero and predicting the forces only in case of interaction.

Furthermore, for certain applications, instead of a constant stiffness Kₑ, the stiffness can also be estimated. For example, a linear spring model Fₑₓₜ=Kₑ(p−p_{ref}) of the environment can be assumed, from which a stiffness can be calculated as follows:

$${\hat{K}}_{e} = \frac{{F}_{ext}}{( p - {p}_{ref} )}$$

Here, p describes the end effector position and p_{ref} a reference position (on the normal of undeformed environment and end effector position) of the undeformed object. The interrelation is shown in FIG. 5.

In order to consider information from a past step in the estimate, a recursive least-squares estimator can be applied. Here, as shown in the scalar case below, the estimated value is updated by the measurement in every time step k.

\hat{K}ₑ(k+1)=\hat{K}ₑ(k)+γ(k+1)(Fₑₓₜ(k)−\hat{K}ₑ(k)(p(k)−p_{ref}(k)))

The weight γ(k+1) determines how strongly the current measurement is considered in the estimate.

As with MPC, the solution of the optimization problems 40 according to MPIC can be done in different ways using different numerical approaches. In various embodiments, the numerical solution is carried out with a gradient method and the extended Lagrange method.

The main idea of this approach is the transformation of the dynamic optimization problem with constraints into an optimization problem without constraints. In other words, the optimization problem is reduced to the optimization of an auxiliary function that has no constraints. For the transformation, the constraints are multiplied by factors, the so-called Lagrange multipliers, and embedded into the target function. Positive Lagrange multipliers are used to punish a violation of the constraints.

The extended Lagrange method further includes a quadratic tightening function, which is embedded into the target function using an additional multiplier.

The resulting auxiliary function, also called the extended Lagrange function, is

L(x,μ,ρ)=f(x)+μg(x)+½ρg(x)²

with the Lagrange multiplier μ and the penalty parameter ρ. Here, the first part f(x)+μg(x) corresponds to the ordinary Lagrange function and the second part ½μg(x)² to a quadratic tightening function. Assuming strong duality and the existence of an optimal solution x*, μ*, it can be shown that for each ρ≤0 the saddle point condition

L(x*,μ,ρ)≤L(x*,μ*,ρ*)≤L(x,μ*,ρ)

must be fulfilled. From this it is apparent that the Lagrange function must be minimized with respect to the variable x and maximized with respect to the Lagrange multipliers μ, i.e. a new optimization problem

$${max}_{u} {min}_{x} L ( x , μ , ρ )$$

must be solved.

For solving this problem, at first, an underlying minimization problem is defined by an iteration k

$${x}^{( k + 1 )} = {arc min}_{x} L ( x , {μ}^{( k )} , {ρ}^{( k )} )$$

which is solved by a gradient method. Afterwards the Lagrange multipliers will be updated by the steepest ascent

μ^{(k)}=μ^{(k)}+ρ^{(k)}g(x^{(k)})

with the penalty parameter ρ(k) as step size. The convergence of the procedure can be significantly improved by adapting the penalty parameter. The heuristics

$${ρ}^{( k + 1 )} = \{ \begin{matrix}{β}_{i n c} {ρ}^{( k )} \vert g ( {x}^{( k )} ) \vert \geq {γ}_{i n c} \vert g ( {x}^{( k - 1 )} ) \vert ⩓ \vert g ( {x}^{( k )} ) \vert > {ɛ}_{g} \\ {β}_{d e c} {ρ}^{( k )} \vert g ( {x}^{( k )} ) \vert \leq {γ}_{d e c} {ɛ}_{g} \\ {ρ}^{( k )} else\end{matrix}$$

with factors β_{inc}>1, β_{dec}<1, γ_{inc} und γ_{dec}<1, and the absolute tolerance ε_{g} has proven itself in practical applications.

If the minimization does not result in a sufficient improvement of the constraints, the penalty parameter is further increased. As soon as the constraint is met with the required tolerance, the penalty parameter can be reduced again. The procedure is repeated until a maximum iteration number k=Nₘᵤₗₜ is reached or the minimization is converged and all constraints are met.

It goes without saying that the above numerical method is only one way to solve the optimization problem. Other methods can be applied in the same way without leaving the scope of the invention.

MPIC enables a uniform set of rules for yield, force and motion control as well as any hybrid forms of these.

The phrase at least one of A, B, and C should be construed to mean a logical (A OR B OR C), using a non-exclusive logical OR, and should not be construed to mean “at least one of A, at least one of B, and at least one of C.”

Overall, the present invention is not limited by the examples of implementation presented here, but is defined by the following claims.

What is claimed is:

1. A method for controlling a robot during an interaction with its environment comprising:
solving an optimization problem for calculating an optimal control variable as an input for a robot controller,
wherein the optimization problem includes interaction dynamics and robot dynamics.

2. The method according to claim 1, wherein:
the robot dynamics corresponds to a dynamic model of the robot; and
the interaction dynamics corresponds to a dynamic force model in which dynamic components are dependent on a robot movement.

3. The method according to claim 1, wherein the optimization problem has a cost function that weights interaction forces.

4. The method according to claim 3, wherein the cost function weights the interaction forces, control variables, and states of the robot.

5. The method according to claim 3, wherein the cost function is designed to minimize the interaction forces.

6. The method according to claim 3, wherein the cost function is designed to optimize the interaction forces to a defined value.

7. The method according to claim 2, wherein the dynamic force model is a description of a change of at least one of an external torque and an external force depending on a stiffness of an environment interacting with the robot and a velocity of the robot.

8. The method according to claim 7, wherein the velocity of the robot is at least one of a joint velocity and a Cartesian velocity.

9. The method according to claim 7, wherein the stiffness of the dynamic force model is assumed to be non-zero in an interaction state, and zero in a non-interacting state.

10. The method according to claim 7, wherein the stiffness of the dynamic force model is assumed constant.

11. An apparatus for controlling a robot during an interaction with its environment, comprising:
a control variable determination unit configured to calculate an optimal control variable as an input for a robot controller by solving an optimization problem,
wherein the optimization problem includes interaction dynamics and robot dynamics.

12. The apparatus according to claim 11, wherein:
the robot dynamics corresponds to a dynamic model of the robot; and
the interaction dynamics corresponds to a dynamic force model in which dynamic components are dependent on a robot movement.

13. The apparatus according to claim 11, wherein the optimization problem has a cost function that weights interaction forces.

14. The apparatus according to claim 13, wherein the cost function weights the interaction forces, control variables, and states of the robot.

15. The apparatus according to claim 13, wherein the cost function is designed to minimize the interaction forces.

16. The apparatus according to claim 13, wherein the cost function is designed to optimize the interaction forces to a defined value.

17. The apparatus according to claim 12, wherein the dynamic force model is a description of a change of at least one of an external torque and an external force depending on a stiffness of an environment interacting with the robot and a velocity of the robot.

18. The apparatus according to claim 17, wherein the velocity of the robot is at least one of a joint velocity and a Cartesian velocity.

19. The apparatus according to claim 17, wherein the stiffness of the dynamic force model is assumed to be non-zero in an interaction state, and zero in a non-interacting state.

20. The apparatus according to claim 17, wherein the stiffness of the dynamic force model is assumed constant.
